(19) United States
(12) Patent Application Publication
(10) Pub. No.: US 2020/0192620 A1
(43) Pub. Date: Jun. 18, 2020

(54) INFORMATION PROCESSING APPARATUS, INFORMATION PROCESSING METHOD, INFORMATION PROCESSING SYSTEM, AND NON-TRANSITORY COMPUTER-READABLE MEDIUM

(71) Applicant: CANON KABUSHIKI KAISHA, Tokyo (JP)

(72) Inventors: Kouichi Kato, Yokohama-shi (JP); Yohei Hashizume, Tokyo (JP)

(21) Appl. No.: 16/802,191

(22) Filed: Feb. 26, 2020

Related U.S. Application Data
(63) Continuation of application No. PCT/JP2018/031300, filed on Aug. 24, 2018.

(30) Foreign Application Priority Data
Sep. 1, 2017 (JP) 2017-168461
Sep. 19, 2017 (JP) 2017-179106

(51) Int. Cl. G06F 3/14; G06T 11/60

(52) U.S. Cl. CPC G06F 3/14; G06T 2210/41; G06T 11/60

(57) ABSTRACT

An information processing apparatus is configured to acquire a first medical image and a second medical image from a database, and control displaying on a display unit such that the second medical image is displayed on the display unit for a period for which a signal is being received which is a signal indicating an instruction to display the second medical image on the display unit and which is transmitted for a period for which one inputting operation is being performed by an operator, and the first medical image is displayed on the display unit for a period for which the signal is not received.

### CROSS-REFERENCE TO RELATED APPLICATIONS

This application is a Continuation of International Patent Application No. PCT/JP2018/031300, filed Aug. 24, 2018, which claims the benefit of Japanese Patent Application No. 2017-168461, filed Sep. 1, 2017 and Japanese Patent Application No. 2017-179106 filed Sep. 19, 2017, which are hereby incorporated by reference herein in their entirety.

### TECHNICAL FIELD

The present disclosure relates to a medical image information processing apparatus, an information processing method, an information processing system, and a non-transitory computer-readable medium.

### BACKGROUND ART

In a medical treatment, a doctor may observe a plurality of medical images and compare them. PTL 1 discloses a technique in which a superimposed perfusion image is generated by superimposing two blood vessel images, and a displayed image is switched according to a request issued by an operator such that one of three images including the superimposed perfusion image and the two blood vessel images is displayed.

### CITATION LIST

### Patent Literature

PTL 1 Japanese Patent Laid-Open No. 2010-213863

### SUMMARY OF INVENTION

In an aspect of the present invention, an information processing apparatus includes acquisition means configured to acquire a first medical image and a second medical image, and display control means configured to control displaying on a display unit such the second medical image is displayed on the display unit for a period for which one operation is being performed on an accepting unit configured to accept an operation performed by an operator, but the first medical image is displayed on the display unit instead of the second medical image when the one operation on the user operation accepting unit is ended.

According to the aspect of the present invention, the information processing apparatus allows an operator such as a doctor to change a medical image displayed on the display unit for an arbitrary period only by performing one operation.

Further features of the present invention will become apparent from the following description of exemplary embodiments with reference to the attached drawings.

### BRIEF DESCRIPTION OF DRAWINGS

FIG. 1 is a diagram illustrating examples of a photoacoustic image, an ultrasonic image, and a superimposed image of the photoacoustic image and the ultrasonic image.

FIG. 2 is a diagram illustrating an example of a functional configuration of an information processing apparatus according to an embodiment of the present invention.

FIG. 3 is a flow chart illustrating an example of a process performed by an information processing apparatus according to an embodiment of the present invention.

FIG. 4 a diagram illustrating an example of a screen displayed by an information processing apparatus according to an embodiment of the present invention.

FIG. 5 a diagram illustrating an example of a screen displayed by an information processing apparatus according to an embodiment of the present invention.

FIG. 6 a diagram illustrating an example of a screen displayed by an information processing apparatus according to an embodiment of the present invention.

FIG. 7 is a diagram illustrating an example of a hardware configuration of an information processing apparatus according to an embodiment of the present invention.

FIG. 8 is a flow chart illustrating an example of a process performed by an information processing apparatus according to an embodiment of the present invention.

FIG. 9A is a diagram illustrating an example of a screen displayed by an information processing apparatus according to an embodiment of the present invention.

FIG. 9B is a diagram illustrating an example of a screen displayed by an information processing apparatus according to an embodiment of the present invention.

FIG. 9C is a diagram illustrating an example of a screen displayed by an information processing apparatus according to an embodiment of the present invention.

FIG. 10A is a diagram illustrating an example of a screen displayed by an information processing apparatus according to an embodiment of the present invention.

FIG. 10B is a diagram illustrating an example of a screen displayed by an information processing apparatus according to an embodiment of the present invention.

FIG. 10C is a diagram illustrating an example of a screen displayed by an information processing apparatus according to an embodiment of the present invention.

### DESCRIPTION OF EMBODIMENTS

Embodiments of the present invention are described below with reference to the drawings.

### First Embodiment

In this specification, a photoacoustic wave refers to an acoustic wave generated by expansion which occurs in a subject when the subject is illuminated with light. An ultrasonic wave refers to an acoustic wave transmitted from a transducer or a reflected wave (echo) of the transmitted acoustic wave reflected inside the subject. The photoacoustic wave and the ultrasonic wave are collectively referred to as an acoustic wave.

As a method for minimally invasive imaging the state inside a subject, it is known to use ultrasonic waves or photoacoustic waves in the imaging. Hereafter, an image formed by using an ultrasonic wave is referred to as an ultrasonic image, and an image formed using a photoacoustic wave is referred to as a photoacoustic image. It is known that a photoacoustic image can be used to observe, for example, blood vessels based on optical characteristics of hemoglobin.

In a medical treatment, in some cases, a doctor acquires a plurality of medical images of a patient under examination and observes the plurality of medical images while comparing them. In observations, various medical image may be displayed on a display unit of a terminal used by the doctor for the observation, and a period of time during which images are displayed may vary. For example, depending on what the doctor is currently observing, information the doctor wants to read from another medical image to be displayed for comparison is different, and accordingly a difference occurs in the period for which the other medical image is displayed.

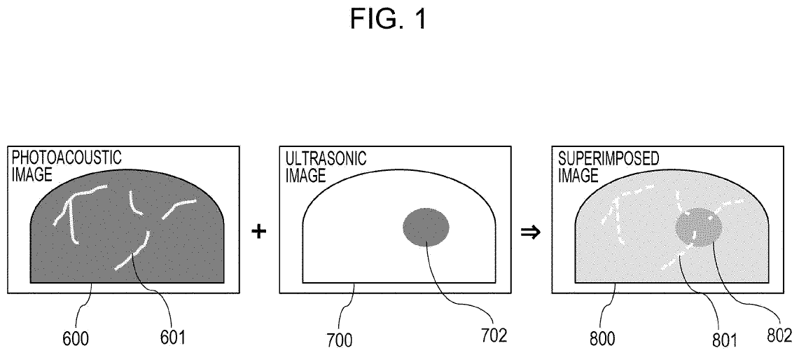

FIG. 1 illustrates an example of a superimposed image obtained by superimposing a plurality of medical images. In this example, a superimposed image 800 is obtained by superimposing a photoacoustic image 600 and an ultrasonic image 700. From the photoacoustic image 600, position information and the like of a blood vessel 601 are obtained, while from the ultrasonic image 700, position information and the like of a tumor 702 are obtained. In some medical treatments, the observation is performed while comparing a plurality of medical images, and different pieces of information obtained from the respective medical images are combined. In an example of a method for making the comparison, a plurality of medical images are superimpose. In the example shown in FIG. 1, the superimposing may provide information about a positional relationship between a tumor and a blood vessel.

Depending on the difference in the luminance value between the photoacoustic image 600 and the ultrasonic image 700, a reduction may occur in the visibility of the blood vessel image 801 in the superimposed image 800. For example, such a reduction in the visibility may occur in a case where the ultrasonic image 700 includes large speckle noise, and the luminance value is high in a large portion of the image. In another example, the superimposition of the photoacoustic image 600 may cause a reduction in the contrast of the superimposed image 800 and thus may cause a reduction in the visibility of the tumor image 802 of the superimposed image 800. As in the examples described above, the luminances of the two images affect each other, and as a result, a reduction may occur in the visibility of information obtained from each image.

Observing a superimposed image obtained by superimposing a plurality of medical images and combining information obtained from the respective medical images is one of useful methods. However, making the comparison using a superimposed image without taking into consideration the luminance balance may not always provide a good result depending on a state of each medical image superimposed together. Performing an inputting operation each time the medical image displayed on the display unit is switched may be troublesome for the doctor. An object of providing an information processing apparatus 100 according to a first embodiment is to enable a doctor to easily compare a plurality of medical images without reducing the visibility of each of the plurality of medical images. The information processing apparatus 100 is configured such that when an operator such as a doctor needs a second medical image when an image interpretation on a first medical image is being performed, if the operator performs one inputting operation, then the second medical image is displayed on a display unit for a desired period.

The medical image displayed on the display unit 110 by the information processing apparatus 100 is an image captured using a modality with, for example, a magnetic resonance image medical apparatus, an ultrasonic image medical apparatus, an optical ultrasonic imaging apparatus, a radiographic image medical apparatus, a computer tomographic image medical apparatus, or a positron emission tomographic apparatus. The medical image may be volume data. The medical image may include annotation information indicating a region of interest (ROI) or the like. In recent years, medical images obtained by various modalities described above, and other medical images used in medical examination and also various kinds of information related to medical examination have been digitized. For example, the DICOM (Digital Imaging and Communications in Medicine) standard is often used for information cooperation between an imaging apparatus and various apparatuses connected to the imaging apparatus. DICOM is a standard that defines the format of medical images and defines the communication protocol between apparatuses that handle those images. According to DICOM, an image, metadata, and image data are handled. The metadata includes, for example, information about a patient, an examination, a series, and an image. The metadata is composed of a collection of data elements called DICOM data elements. A tag for identifying the data element is added to each DICOM data element. For example, in a DICOM data element, a tag indicating image data is added to image data that is pixel data. In the first embodiment, medical images and processing performed by the information processing apparatus 100 conform to DICOM. As for information necessary for various processes, information included in metadata of a medical image or information obtained by inquiring of an external apparatus in accordance with DICOM is used.

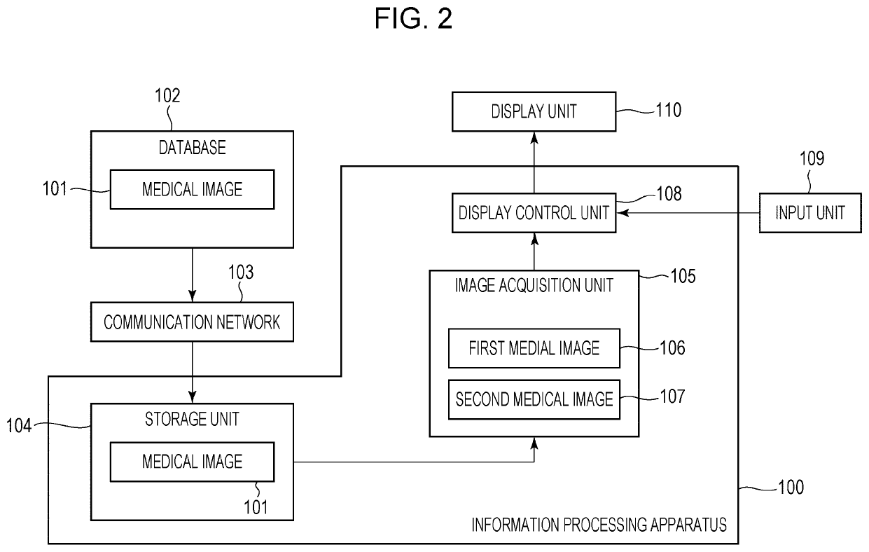

FIG. 2 is a diagram illustrating an example of a functional configuration of the information processing apparatus 100. The information processing apparatus 100 is connected, via a communication network 103, to a database 102 for storing medical images 101. The database 102 is, for example, a PACS (Picture Archiving and Communication System). The information processing apparatus 100 includes a storage unit 104, an image acquisition unit 105, and a display control unit 108. The information processing apparatus 100 is connected to an input unit 109 and a display unit 110.

The storage unit 104 stores the plurality of medical images 101 acquired from the database 102 by the image acquisition unit 105. The image acquisition unit 105 acquires a medical image from the database 102. In another example, the image acquisition unit 105 may acquire a medical image from a medical imaging apparatus (not shown), which is also called a modality. The image acquisition unit 105 may perform image processing on the medical image 101. The image processing is, for example, a registration process for aligning features between two images, a process of superimposing two registered images, and a maximum intensity projection (MIP) for volume data. Hereinafter, an image obtained by superimposing two images is referred to as a superimposed image, and an image generated via the maximum intensity projection process is referred to as a projected image.

The image acquisition unit 105 acquires at least two medical images for use in comparison and observation by the operator. Herein, they are respectively referred to as a first medical image 106 and a second medical image 107. The second medical image 107 is a medical image different from the first medical image 106. Each of the first medical image 106 and the second medical image 107 may be a medical image acquired from the database 102, or a medical image such as a projected image obtained via image processing performed by the image acquisition unit 105. The image acquisition unit 105 may store the acquired medical images in the database 102. From this viewpoint, the image acquisition unit 105 is an example of acquisition means that acquires the first medical image and the second medical image.

The display control unit 108 control displaying on the display unit 110 such that either the first medical image 106 or the second medical image 107 is displayed on the display unit 110. More specifically, the display control unit 108 receives a signal transmitted from the input unit 109. The display control unit 108 controls displaying on the display unit 110 such that the second medical image 107 is displayed on the display unit 110 for a period of time for which the signal indicating an instruction to display the second medical image 107 is being received from the input unit 109. On the other hand, the display control unit 108 controls displaying on the display unit 110 such that the first medical image 106 is displayed on the display unit 110 for a period in which the signal indicating the instruction to display the second medical image 107 is not received from the input unit 109. That is, the display control unit 108 controls displaying on the display unit 110 such that the first medical image 106 is displayed on the display unit 110, and the second medical image 107 is displayed only for a period for which the signal from the input unit 109 is being received. From this viewpoint, the display control unit 108 is an example of display control means that controls displaying on the display unit 110 such that the second medical image is displayed on the display unit 110 for a period for which the signal transmitted as long as one inputting operation by the operator is continued is being received, but the first medical image is display for a period in which the signal is not received.

The input unit 109 inputs an instruction given by the operator to the information processing apparatus 100. The input unit 109 is, for example, a keyboard, a mouse, a joystick, a touch panel, a switch box, a microphone configured to receive sound including a voice, or an apparatus configured to accept a specific gesture. From the viewpoint that the input unit 109 operates as an apparatus that accepts an instruction to control displaying on the display unit 110 such that the second medical image 107 is displayed on the display unit 110, the input unit 109 functions as a momentary switch. In a case where the input unit 109 functions as an alternate switch, the operator is supposed to perform an operation of issuing an instruction, which may be troublesome. The functioning of the input unit 109 as the momentary switch allows the operator to input an instruction to display the second medical image 107 only for a desired period by performing a simple inputting operation. In this respect, the input unit 109 is an example of an accepting unit configured to accept an operation performed by the operator.

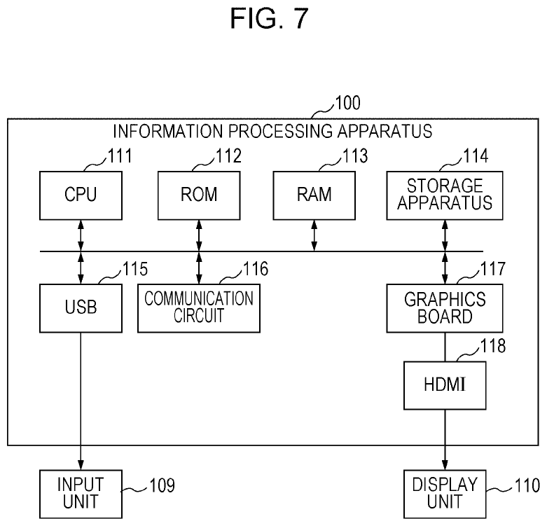

FIG. 7 is a diagram illustrating an example of a hardware configuration of the information processing apparatus 100. The information processing apparatus 100 is, for example, a computer. The information processing apparatus 100 includes a CPU 111, a ROM 112, a RAM 113, a storage apparatus 114, a USB 115, a communication circuit 116, and a graphics board 117. These are connected to each other via a BUS such they can communicate with each other. The BUS is used for transmitting and receiving data between connected hardware and transmitting an instructions from the CPU 111 to another hardware.

The CPU (Central Processing Unit) 111 is a control circuit that integrally controls the information processing apparatus 100 and each unit connected thereto. The CPU 111 executes control by executing a program stored in the ROM 112. The CPU 111 executes a display driver, which is software for controlling the display unit 110, and performs display control on the display unit 110. Furthermore, the CPU 111 performs input/output control on the input unit 109.

The ROM (Read Only Memory) 112 stores a program in which a control procedure to be executed by the CPU 111 is described and also stored data. The ROM 112 stores a boot program of the information processing apparatus 100 and various initial data. The ROM 112 also stores various programs for realizing the processing performed in the information processing apparatus 100.

The RAM (Random Access Memory) 113 provides a working storage area when the CPU 111 performs control according to an instruction program. The RAM 113 has a stack and a work area. The RAM 113 stores a program for executing processing in the information processing apparatus 100 and various units connected to the information processing apparatus 100 and also stores various parameters used in image processing. The RAM 113 stores a control program to be executed by the CPU 111, and temporarily stores various data when the CPU 111 executes various controls.

The storage apparatus 114 is an auxiliary storage apparatus that stores various data such as the first medical image 106, the second medical image 107, and the like. The storage apparatus 114 is, for example, an HDD (Hard Disk Drive) or an SSD (Solid State Drive).

The USB (Universal Serial Bus) 115 is a connection unit for connecting to the input unit 109.

The communication circuit 116 is a circuit for communicating with various external apparatuses connected to the communication network 103. The communication circuit 116 outputs information to an external apparatus such that the information to be output is stored a transfer packet, and is output to the external apparatus via a communication network 103 using communication technology such as TCP/IP. The information processing apparatus 100 may include a plurality of communication circuits to adapt to a desired communication mode.

The graphics board 117 includes a GPU (Graphics Processing Unit) and a video memory. The GPU performs, for example, an operation related to a reconstruction process for generating a photoacoustic image from a photoacoustic signal.

An HDMI (registered trademark) (High Definition Multimedia Interface) 118 is a connection unit for connection to the display unit 110.

The CPU 111 and the GPU are examples of processors. The ROM 112, the RAM 113, and the storage apparatus 114 are examples of memories. The information processing apparatus 100 may include a plurality of processors. In the first embodiment, the function of each unit of the information processing apparatus 100 is realized by the processor of the information processing apparatus 100 by executing a program stored in the memory.

Furthermore, the information processing apparatus 100 may include a CPU, a GPU, and an ASIC (Application Specific Integrated Circuit) dedicated to specific processing. The information processing apparatus 100 may include an FPGA (Field-Programmable Gate Array) in which specific processing or all processing is programmed.

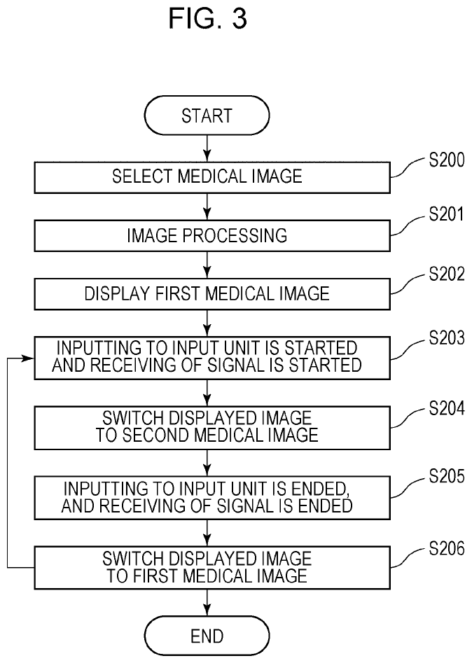

FIG. 3 is a flow chart illustrating an example of a process performed by the information processing apparatus 100 according to the first embodiment.

S200: Step of Selecting a Medical Image

In step S200, the image acquisition unit 105 selects a first medical image and a second medical image based on an instruction issued by an operator. In the first embodiment, an explanation is given, by way of example, for a case where an operator such as a doctor selects a plurality of medical images as target images to be compared and observed. From the viewpoint of comparing a plurality of medical images, a combination of a plurality of medical images that can be registered with each other is selected in step S200. An example of a combination of medical images that can be aligned is, for example, such a combination of medical images captured for the same region or an overlapping region of a subject. The image acquisition unit 105 acquires the selected medical images from the database 102 or the storage unit 104.

The doctor may perform an operation called an image interpretation in which the first medical image and the second medical image and/or the like are displayed on one screen and the doctor observes the displayed images. The information processing apparatus 100 may provide a function for the image interpretation. The function for the image interpretation includes a function of superimposing the first medical image and the second medical image, a function of changing a mode of displaying the images on the screen, for example, according to an inputting operation performed by a user. Therefore, in an example of the embodiment, it is assumed that the first medical image and the second medical image have been registered in advance. The registration is a process of aligning two images such that features of the respective images coincide with each other. The registration may be performed by a procrates method, an ICP (iterative closest point) algorithm, an algorithm based on the density characteristics of two images, an algorithm using a physical model, or the like, and any constraint may be used. In a case where the first medical image and the second medical image are respectively an ultrasonic image and a photoacoustic image obtained with one probe, the registration may be performed based on the position of the probe with respect to the subject.

S201: Step of Performing Image Processing

In step S201, when a medical image selected in step S200 is, for example, a projected image or a superimposed image, the image acquisition unit 105 generates it. In a case where the medical images selected in step S200 do not require any particular image processing, the processing in step S201 may not be performed.

In a case where a projected image is selected in step S200, the image acquisition unit 105 performs an image projection process on the medical images acquired from the database 102 or the storage unit 104. In a case where a superimposed image is selected in step S200, the image acquisition unit 105 generates a superimposed image using medical images acquired from the database 102 or the storage unit 104. In the generation of the superimposed image, the image acquisition unit 105 increases the transparency of one of the medical images according to an instruction issued by the operator. This makes it possible to reduce the possibility that the luminances of a plurality of medical images superimposed together affect each other, which results in a reduction in visibility of information obtained from each medical image.

S202: Step of Displaying the First Medical Image

In the first embodiment, an image displayed during a period in which no signal is received from the input unit 109 denotes a first medical image, while an image displayed during a period in which a signal is received from the input unit 109 denotes a second medical image.

In step S202, because no signal is received from the input unit 109, the display control unit 108 controls displaying on the display unit 110 so as to display the first medical image on the display unit 110. More specifically, the display control unit 108 controls displaying on the display unit 110 so as to display a slice image included in volume data selected as the first medical image in step S200, or the projected image or the superimposed image generated in step S201 is displayed on display unit 110 as the first medical image.

S203: Step of Starting the Signal Reception

In step S203, the information processing apparatus 100 starts receiving a signal from the input unit 109. The first medical image is already displayed on the display unit 110 via the processing up to step S203. In this state, the operator such as a doctor inputs an instruction to display the second medical image on the display unit 110 to the information processing apparatus 100 via the input unit 109. The instruction is issued by one inputting operation performed by the operator. The input unit 109 transmits a signal to the information processing apparatus 100 in a period in which the one inputting operation is performed. In response to starting the one inputting operation by the operator, the signal is transmitted from the input unit 109, and the information processing apparatus 100 starts receiving the signal indicating an instruction to display the second medical image on the display unit 110.

S204: Step of Switching the Displayed Image to the Second Medical Image

In step S204, the display control unit 108 controls the display unit 110 to display the second medical image. In accordance with the instruction to display the second medical image issued by the operator such as a doctor via the input unit 109, the display unit 110 changes the displayed image from the first medical image to the second medical image. The displaying of the second medical image is continuously performed while the operator continues inputting.

S205: Step of Ending Inputting to the Input Unit

In step S205, the information processing apparatus 100 ends receiving the signal from the input unit 109. The second medical image is already displayed on the display unit 110 via the processing up to step S205, and the operator ends issuing the instruction to display the second medical image on the display unit 110. Ending of issuing the instruction is performed in response to ending the one inputting operation started in step S203. That is, the operator starts and ends the one inputting operation in the process from step S203 to step S205. As a result, the input unit 109 stops transmitting the signal to the information processing apparatus 100.

S206: Step of Switching the Displayed Image to the First Medical Image

In step S206, the display control unit 108 controls displaying on the display unit 110 so as to display the first medical image. That is, because the operator has finished inputting, via the input unit 109, the instruction to display the second medical image, no signal is transmitted from the input unit 109 to the information processing apparatus 100. The display control unit 108 controls displaying such that the image display on the display unit 110 is switched from the second medical image to the first medical image. Unless the instruction is again input to input unit 109, the first medical image is continuously displayed on the display unit 110.

When the instruction is again input to input unit 109 and the information processing apparatus 100 begins to receive the signal indicating the instruction, the process proceeds to step S203 and repeats the process up to step S206. This makes it possible to switch the displayed image from the first medical image to the second medical image and continuously display the second medical image only for a period intended by the operator. This makes it possible to switch the displayed image from the first medical image to the second medical image and continuously display the second medical image only for a period intended by the operator.

After necessary information is read from the second medical image displayed on the display unit 110 for a desired period of time, if the doctor finishes inputting the instruction to display the second medical image, then the displayed image is quickly changed to the first medical image. Thus, it is possible to observe the first medical image when information read from the second medical image such as information on a position and a shape of a lesion, a signal strength, and/or the like is being stored. Since the displayed image is switched between the first medical image and the second medical image, the doctor can observe both the first medical image and the second medical image with good visibility.

The doctor can switch between the first medical image and the second medical image by performing a simple inputting operation and can observe the displayed image for a desired period. In a case where the doctor uses, for example, an alternate switch to instruct to switch the displayed image between the first medical image and the second medical image, the doctor has to perform two inputting operations, respectively, at the starting switching and at the ending switching, which may be troublesome. In the example according to the first embodiment, the doctor is supposed to perform only one inputting operation to issue the instruction for switching using the momentary switch. The information processing apparatus according to the first embodiment displays the second medical image on the display unit 110 continuously for the period for which one operation is being performed by the operator on the accepting unit configured to accept an operation performed by the operator, for example, for the period for which the momentary switch is kept pressed down. The information processing apparatus according to the first embodiment displays the second medical image on the display unit 110 continuously for the period for which one operation is being performed by the operator on the accepting unit configured to accept an operation performed by the operator, for example, for the period for which the momentary switch is kept pressed down. This allows the doctor to easily and repeatedly switch the displayed image between the first medical image and the second medical image. For example, the operator can issue an instruction to quickly switch the displayed image, for example, about 10 times in 5 seconds, and the information processing apparatus 100 can perform switching the displayed image in accordance with the instruction. By repeatedly performing the switching the displayed image in the manner described above, the doctor can check and combine the information read from the first medical image and the information read from the second medical image before forgetting, which allows the doctor to observe the medical images in an efficient manner.

### First Specific Example

A specific example is described below for a case where both the first medical image and the second medical image are two-dimensional images included in volume data so-called slice images.

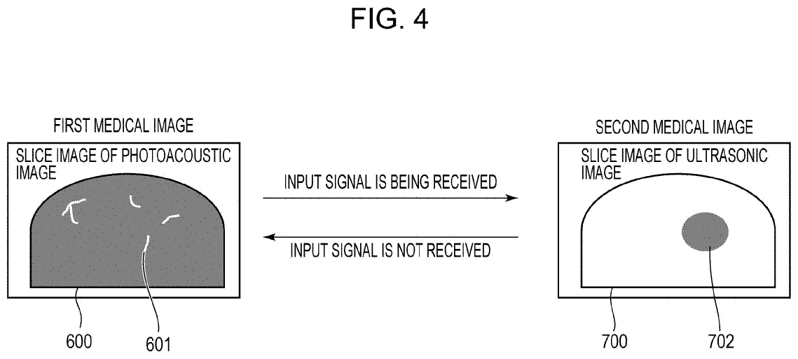

FIG. 4 is a diagram illustrating an example of a screen displayed on the display unit 110 according to a first specific example. In this example, the first medical image is a photoacoustic image 600 and the second medical image is an ultrasonic image 700. As described above, the display unit 110 switches the displayed image between the slice image included in the photoacoustic image 600 and the slice image included in the ultrasonic image 700. It is assumed that the photoacoustic image 600 and the ultrasonic image 700 have been subjected to the alignment processing.

Each process in the flow chart illustrated by way of example in FIG. 3 will be specifically described below.

S200: Step of Selecting a Medical Image

In step S200, the image acquisition unit 105 selects volume data of the photoacoustic image 600 as the first medical image and volume data of the ultrasonic image 700 as the second medical image according to the instruction issued by the operator. Since the medical images selected here do not need particular image processing, the process in step S201 is not performed.

S202: Step of Displaying the First Medical Image

In step S202, the display control unit 108 controls displaying on the display unit 110 so as to display the slice image, specified by the operator, in the volume data of the photoacoustic image 600 as the first medical image. The operator is allowed to arbitrarily change the position of the slice image displayed on the display unit 110. The operator can observe a blood vessel image 601 from the photoacoustic image 600 selected as the first medical image.

S203: Step of Starting Inputting to the Input Unit

In a case where the operator wants to display the ultrasonic image 700 as the second medical image on the display unit 110, the operator inputs the instruction to the information processing apparatus 100 via the input unit 109. After the operator starts inputting to the input unit 109, the operator keeps the inputting for a period in which the operator wants to continuously display the second medical image. The information processing apparatus 100 starts receiving a signal indicating the instruction. The input unit 109 functions as the momentary switch. After the operator starts pressing a mouse button or a specific keyboard button, the operator keeps pressing.

S204: Step of Switching the Displayed Image to the Second Medical Image

In step S204, the display control unit 108 controls displaying on the display unit 110 so as to display the second medical image for a period for which the signal indicating the instruction is being received. That is, while the operator is inputting the instruction, the second medical image switched from the first medical image is kept displayed on the display unit 110. The display control unit 108 controls displaying on the display unit 110 so as to display a slice image of the ultrasonic image 700 at a position corresponding to the slice image of the photoacoustic image 600 which is displayed on the display unit 110 when the signal indicating the instruction is input from the input unit 109. While the second medical image is being displayed, the operator is allowed to arbitrarily change the position of the displayed slice image. The operator can observe a tumor image 702 from the ultrasonic image 700 selected as the second medical image.

S205: Step of Ending Inputting to the Input Unit

When it is desired to switch the displayed image again to the first medical image after information has been obtained from the slice image of the ultrasonic image 700 of the second medical image, the inputting to the input unit 109 is ended. The operator ends the continuous pressing of the mouse button or the specific keyboard button. That is, the operator ends the one operation.

S206: Step of Switching the Displayed Image to the First Medical Image

In step S206, in response to ending of the reception of the signal indicating the instruction from the input unit 109, the display control unit 108 controls displaying on the display unit 110 so as to display the slice image of the photoacoustic image 600 selected as the first medical image. The display control unit 108 controls displaying on the display unit 110 so as to display the slice image of the photoacoustic image 600 at the position corresponding to the position where the slice image of the ultrasonic image 700 is displayed when the signal from the input unit 109 is stopped.

Note that in a case where the position of a two-dimensional image (a slice image) included in the second medical image is changed in a period during which the one operation by the operator for displaying the second medical image on the display unit 110 is continued, the position of the first medical image displayed on the display unit 110 in step S206 is determined based on, for example, information related to the registration. The first medical image and the second medical image are registered in advance, and they are associated with each other in terms of the coordinates thereof. In step S206, the first medical image is displayed at a slice position (a position on the Z-axis of the first medical image) corresponding to the slice position (the position on the Z-axis) of the slice image (for example, a two-dimensional image in the XY plane) displayed in step S204.

In a case where the position of the slice image of the second medical image has been changed in step S204, if the same slice image of the first medical image as that in step S202 is displayed in step S205 after the one operation for displaying the second medical image is ended, then the displayed image is switched to a slice image that does not correspond to the slice image observed by the doctor immediately before. Such a situation may cause a reduction in the efficiency with which the doctor observes the first medical image and the second medical image may be reduced. According to the first specific example, the slice image of the first medical image at the position corresponding to the slice image displayed on the display unit 110 until immediately before is displayed on the display unit 110 in step S206, and thus the doctor can efficiently observe the medical images.

By switching the displayed image between the first medical image and the second medical image, the operator such as a doctor can observe the first and second medical images by easily combining the information on the tumor image 702 and the information on the blood vessel image 601.

### Second Specific Example

In a specific example described below, both or one of the first medical image and the second medical image is a projected image.

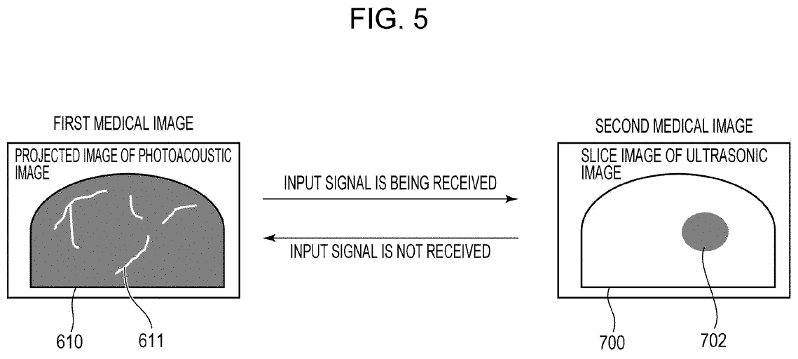

FIG. 5 is a diagram illustrating an example of a screen displayed on the display unit 110 according to a second specific example. In this example, the first medical image is a projected image 610 of the photoacoustic image 600 and the second medical image is an ultrasonic image 700. As described above, the image displayed on the display unit 110 is switched between the projected image 610 and the slice image included in the ultrasonic image 700. It is assumed that the photoacoustic image 600 and the ultrasonic image 700 have been subjected to the alignment processing.

Each process in the flow chart illustrated by way of example in FIG. 3 will be specifically described below.

S200: Step of Selecting a Medical Image

In step S200, the image acquisition unit 105 selects a projected image of the photoacoustic image 600 as the first medical image and volume data of the ultrasonic image 700 as the second medical image according to the instruction issued by the operator.

S201: Step of Performing Image Processing

In step S201, the image acquisition unit 105 performs the maximum intensity projection process on the photoacoustic image 600 thereby generating a projected image 610. If the photoacoustic image is displayed as a thin slice image with a thickness of about 0.1 mm, then, in some cases, a blood vessel image is displayed in the form of a dot-like image, which may make it difficult to recognize a connection of a blood vessel. As a result of the maximum intensity projection process, blood vessel images appearing in respective slice images are integrated into the projected image 610, which makes it possible to easily recognize connections and shapes of the blood vessels.

S202: Step of Displaying the First Medical Image

In step S202, the display control unit 108 selects, as the first medical image, the projected image 610 of the photoacoustic image 600 within a projection range specified by an instruction issued by the operator, and controls displaying on the display unit 110 so as to display the selected image. The operator is allowed to arbitrarily change the projection range of the projected image 610. The operator can observe a blood vessel image 611 from the projected image 610 selected as the first medical image.

S203: Step of Starting Inputting to the Input Unit

In a case where the operator wants to display the ultrasonic image 700 as the second medical image on the display unit 110, the operator inputs an instruction to display the second medical image to the information processing apparatus 100 via the input unit 109. After the operator starts inputting to the input unit 109, the operator keeps the inputting for a period in which the operator wants to continuously display the second medical image. The information processing apparatus 100 starts receiving a signal indicating the instruction. The input unit 109 functions as the momentary switch. After the operator starts pressing a mouse button or a specific keyboard button, the operator keeps pressing.

S204: Step of Switching the Displayed Image to the Second Medical Image

In step S204, the display control unit 108 controls displaying on the display unit 110 so as to display the second medical image for a period for which the signal indicating the instruction is being received. That is, while the operator is inputting the instruction, the second medical image switched from the first medical image is kept displayed on the display unit 110. The display control unit 108 controls displaying on the display unit 110 so as to display a slice image of the ultrasonic image 700 at a position included in the projection range of the projected image 610 which is displayed on the display unit 110 when the signal indicating the instruction is input from the input unit 109. While the second medical image is being displayed, the operator is allowed to arbitrarily change the position of the displayed slice image. The operator can observe a tumor image 702 from the ultrasonic image 700 selected as the second medical image.

S205: Step of Ending Inputting to the Input Unit

After the operator acquires information from the slice image of the ultrasonic image 700 selected as the second medical image, if the operator wants to change the displayed image to the first medical image, then the operator stops the inputting operation on the input unit 109. The operator stops the continuous pressing of, for example, the mouse button or the specific keyboard button.

S206: Step of Switching the Displayed Image to the First Medical Image

In step S206, in response to ending of the reception of the signal indicating the instruction from the input unit 109, the display control unit 108 controls displaying on the display unit 110 so as to display the projected image 610 as the first medical image. The projected image 610, in the projection range, at a position corresponding to the slice image of the ultrasonic image 700 displayed at the ending of the signal from the input unit 109, is displayed on the display unit 110.

By switching the displayed image between the first medical image and the second medical image, the operator such as a doctor can observe the first and second medical images by easily combining the information on the tumor image 702 and the information on the blood vessel image 611.

### Third Specific Example

In a specific example described below, both of the first medical image and the second medical image are superimposed images.

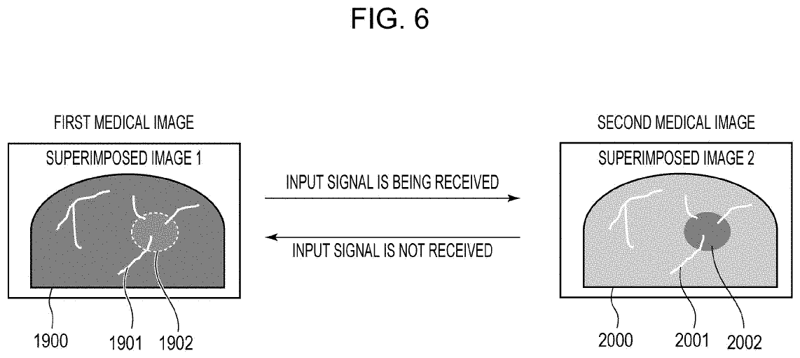

FIG. 6 is a diagram illustrating an example of a screen displayed on the display unit 110 according to a third specific example. In this example, each of the first medical image and the second medical image is a superimposed image obtained by superimposing a photoacoustic image and an ultrasonic image. In this example, each of the first medical image and the second medical image is a superimposed image obtained by superimposing a photoacoustic image and an ultrasonic image.

In the following description, it is assumed that the first medical image is a superimposed image 1900 obtained by superimposing an ultrasonic image with an increased transparency on a photoacoustic image, while the second medical image is a superimposed image 2000 obtained by superimposing the photoacoustic image with an increased transparency on the ultrasonic image.

In this example, each of the first medical image and the second medical image is a superimposed image obtained by superimposing a photoacoustic image and an ultrasonic image. Note that a projected image may be used instead of a slice image for a superimposed image.

Each process in the flow chart illustrated by way of example in FIG. 3 will be specifically described below.

S200: Step of Selecting a Medical Image

In step S200, the image acquisition unit 105 selects a superimposed image obtained by superimposing a photoacoustic image and an ultrasonic image for each of the first medical image and the second medical image.

S201: Step of Performing Image Processing

The image acquisition unit 105 generates, as the first medical image, a superimposed image 1900 by superimposing an ultrasonic image with increased transparency on a photoacoustic image. Furthermore, the image acquisition unit 105 generates, as the second medical image, a superimposed image 2000 superimposing a photoacoustic image with increased transparency on an ultrasonic image. In this example, the superimposed image 1900 given as the first medical image is obtained by superimposing the photoacoustic image and the ultrasonic image with a superimposition ratio of 80% to 20%. On the other hand, the superimposed image 2000 given as the second medical image is obtained by superimposing the photoacoustic image and the ultrasonic image with a superimposition ratio of 30% to 70%.

### (S202: Step of Displaying the First Medical Image)

In step S202, the display control unit 108 controls displaying on the display unit 110 so as to display a slice image included in the superimposed image 1900 as the first medical image. The operator is allowed to arbitrarily change the position of the displayed slice image of the superimposed image 1900.

In a case where a superimposed image using a projected image is displayed, the operator is allowed to arbitrarily change the projection range of the projected image.

In the example shown in FIG. 6, the first medical image contains information of the photoacoustic image dominantly, and the operator such as a doctor can observe the blood vessel image 1901 from the superimposed image 1900.

S203: Step of Starting Inputting to the Input Unit

When the operator wants to display the superimposed image 2000 as the second medical image on the display unit 110, the operator inputs an instruction to display the second medical image to the information processing apparatus 100 via the input unit 109. After the operator starts inputting to the input unit 109, the operator keeps the inputting for a period in which the operator wants to continuously display the second medical image. The information processing apparatus 100 starts receiving a signal indicating the instruction. The input unit 109 functions as the momentary switch. After the operator starts pressing a mouse button or a specific keyboard button, the operator keeps pressing.

S204: Step of Switching the Displayed Image to the Second Medical Image

In step S204, the display control unit 108 controls displaying on the display unit 110 so as to display the second medical image for a period for which the signal indicating the instruction is being received. That is, while the operator is inputting the instruction, the second medical image switched from the first medical image is kept displayed on the display unit 110. Under the control of the display control unit 108, the display unit 110 displays a slice image of the superimposed image 2000 of a position corresponding to the slice image of the superimposed image 1900 displayed on the display unit 110 when the signal indicating the instruction is input from the input unit 109. While the second medical image is being displayed, the operator is allowed to arbitrarily change the position of the displayed slice image.

In a case where the first medical image is a superimposed image based on the projected image, a slice image of the superimposed image 2000 at a position included in the projection range of the projected image is displayed on the display unit 110 in the same manner as in the second specific example.

In the example shown in FIG. 6, the second medical image contains information of the ultrasonic image dominantly, and the operator such as a doctor can observe the tumor image 2002 from the superimposed image 2000.

S205: Step of Ending Inputting to the Input Unit

After the operator acquires information from the superimposed image 2000 selected as the second medical image, if the operator wants to change the displayed image to the first medical image, then the operator stops the inputting operation on the input unit 109. The operator stops the continuous pressing of, for example, the mouse button or the specific keyboard button.

S206: Step of Switching the Displayed Image to the First Medical Image

In step S206, in response to ending of the reception of the signal indicating the instruction from the input unit 109, the display control unit 108 controls displaying on the display unit 110 so as to display the superimposed image 1900 as the first medical image. The display unit 110 displays a slice image of the superimposed image 1900 at a position corresponding to the slice image of the superimposed image 2000 displayed on the display unit 110 when the signal indicating the instruction from the input unit 109 is ended.

By switching the displayed image between the first medical image and the second medical image, the operator such as a doctor can observe the first and second medical images by easily combining the information on the tumor image 2002 and the information on the blood vessel image 1901.

In the third specific example, since the first medical image and the second medical image both use a superimposed image, there is a possibility that even after the displayed medical image is switched, information read from the previously displayed image can be observed. For example, when the operator observers the second medical image, it is possible to observe the blood vessel image 2001 corresponding to the blood vessel image 1901 of the first medical image. On the other hand, when the operator observes the first medical image, it is possible to observer the tumor image 1902 corresponding to the tumor image 2002 of the second medical image.

Modifications of First Embodiment

The embodiment has been described above, by way of example, for the case where the displayed image is switched between two medical images, but the displayed image may be switched among three or more medical images. For example, the information processing apparatus 100 may include a plurality of input units depending on a pattern of switching medical images. More specifically, the information processing apparatus 100 may switch the displayed image among a photoacoustic image, an ultrasonic image, and a nuclear magnetic resonance stereoscopic image. The information processing apparatus 100 may receive, from an input unit A, a signal instructing switching between the photoacoustic image and the ultrasonic image, may receive, from an input unit B different from the input unit A, a signal instructing switching between the photoacoustic image and the nuclear magnetic resonance image, and may receive, from an input unit C different from the input units A and B, a signal instructing switching between the ultrasonic image and the nuclear magnetic resonance image. In this case, a determination may be made in advance as to the type of a medical image to be displayed on the display unit 110 when no signal is received from any input unit.

The embodiment has been described above, by way of example but not limitation, for the case where the display control unit 108 receives a signal transmitted from the input unit 109. Alternatively, for example, the information processing apparatus 100 may include receiving means (not shown) that is a module different from the display control unit 108 and that is configured to receive a signal transmitted from the input unit 109.

In the embodiment described above, an explanation has been given by way of example for the case where an ultrasonic image or a photoacoustic image are used as the first medical image and/or the second medical image. However, in the present invention, medical information acquired by an arbitrary modality (an image capturing apparatus) may be used, and the first medical image and the second medical image may be in an arbitrary combination with medical information. Examples of modalities include digital radiography, an X-ray CT apparatus, an MRI apparatus, a SPECT apparatus, a SPECT/CT apparatus, a PET apparatus, a PET/CT apparatus, a PET/MRI apparatus, an ultrasonic imaging apparatus, a photoacoustic imaging apparatus, a fundus camera, an OCT apparatus. In a case where a combination of an ultrasonic image and a photoacoustic image is used as used by way of example in the above embodiment, these images may be obtained, for example, by a modality configured such a function of emitting an ultrasonic waves, a function of emitting light, and a function of receiving ultrasonic waves (reflected waves and acoustic waves) are all provided by a single probe. This configuration makes it possible to acquire both an ultrasonic image and a photoacoustic image of the same subject in the same examination, which may result in a reduction in a registration error. In addition, the ultrasonic image and the photoacoustic image provide images of different structures in the subject, and thus the ultrasonic image and the photoacoustic image provide complimentary information.

### Second Embodiment

The information processing apparatus according to a second embodiment has a similar functional configuration and a similar hardware configuration as described above with reference to FIG. 2 and FIG. 7. Parts of the configuration same as those in the first embodiment have already been described above, and thus a further detailed description thereof is omitted. Hereinafter, differences from the first embodiment will be described.

The display control unit 108 controls displaying on the display unit 110 so as to display at least one of the first medical image 106 and the second medical image 107. In addition, according to the signal from the input unit 109, the first medical image 106 and the second medical image 107 are displayed on the display unit 110 such that luminance of each image is changed with time. More specifically, the display control unit 108 receives a signal transmitted from the input unit 109. This signal indicates an instruction issued by the operator to display the second medical image 107 on the display unit 110. In response to receiving the signal from the input unit 109, the display control unit 108 controls displaying on the display unit 110 so as to display the second medical image 107. The display control unit 108 changes, with time, the luminance of the second medical image 107 displayed on the display unit 110 over time. More specifically, the luminance of the second medical image 107 is reduced within a preset period of time. When the second medical image 107 is displayed, the display control unit 108 stops displaying of the first medical image 106 or may reduce the luminance thereof and may increase the luminance of the first medical image 106 as the luminance of the second medical image 107 is reduced. That is, the display control unit 108 may change, with time, the luminance of the first medical image 106. It is assumed that the display control unit 108 uses the clock signal of the CPU 111 to change the luminance of the medical image. The display control unit 108 may include a timer, and may use the timer to change the luminance of the medical image. In this respect, the display control unit 108 is an example of display control means.

The input unit 109 inputs an instruction given by the operator to the information processing apparatus 100. The input unit 109 is, for example, a keyboard, a mouse, a joystick, a touch panel, a switch box, a microphone configured to receive sound including a voice, or an apparatus configured to accept a specific gesture. In this respect, the display control unit 109 is an example of inputting means for use by the operator to perform inputting operation.

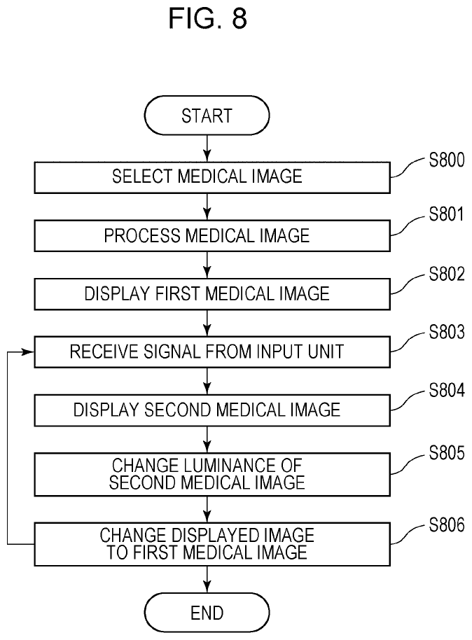

FIG. 8 is a flow chart illustrating an example of a process performed by the information processing apparatus 100 according to the second embodiment.

S800: Step of Selecting a Medical Image

In step S800, the image acquisition unit 105 selects the first medical image and the second medical image based on an instruction issued by the operator. In the second embodiment, an example is described in which the operator such as a doctor selects a plurality of medical images to be compared and observed. From the viewpoint of comparing a plurality of medical images, a combination of a plurality of medical images that can be registered with each other is selected in step S800. An example of a combination of medical images that can be registered with each other is, for example, such a combination of medical images captured for the same region or an overlapping region of a subject. The image acquisition unit 105 acquires the selected medical images from the database 102 or the storage unit 104.

S801: Step of Performing Image Processing

In step S801, when the medical image selected in step S800 is, for example, a projected image or a superimposed image, the image acquisition unit 105 generates it. In a case where the medical images selected in step S800 do not require any particular image processing, the processing in step S801 may not be performed.

In a case where a projected image is selected in step S800, the image acquisition unit 105 performs an image projection process on the medical images acquired from the database 102 or the storage unit 104. In a case where a superimposed image is selected in step S800, the image acquisition unit 105 generates a superimposed image using medical images acquired from the database 102 or the storage unit 104. In the generation of the superimposed image, the image acquisition unit 105 reduces the luminance of one of the medical images according to an instruction issued by the operator. This makes it possible to reduce the possibility that the luminances of a plurality of medical images superimposed together affect each other, which results in a reduction in visibility of information obtained from each medical image.

S802: Step of Displaying the First Medical Image

In step S802, the display control unit 108 controls displaying on the display unit 110 so as to display the first medical image 106. More specifically, in step S800, the display control unit 108 controls displaying on the display unit 110 so as to display a slice image included in the volume data selected as the first medical image 106, or the display control unit 108 controls displaying on the display unit 110 so as to display the projected image or the superimposed image generated in step S801 as the first medical image 106.

S803: Step of Receiving a Signal from the Input Unit

In step S803, the information processing apparatus 100 receives a signal from the input unit 109. The first medical image 106 is already displayed on the display unit 110 via the processing up to step S803. In this state, the operator such as a doctor inputs an instruction to display the second medical image 107 on the display unit 110 to the information processing apparatus 100 via the input unit 109. The input unit 109 transmits a signal to the information processing apparatus 100.

S804: Step of Displaying the Second Medical Image

In step S804, the display control unit 109 controls displaying on the display unit 1100 so as to display the second medical image 107. In this situation, the display control unit 108 may keep the first medical image 106 displayed on the display unit 110, or may switch the displayed image from the first medical image 106 to the second medical image 107. When the display control unit 108 controls displaying on the display unit 110 so as to display the second medical image 107, the display control unit 108 starts counting of time during which the second medical image 107 is displayed.

S805: Step of Changing the Luminance of the Second Medical Image

In step S805, the luminance of the second medical image 107 displayed on the display unit 110 is changed with time according to presetting. In an embodiment, the display control unit 108 changes the luminance of the first medical image 106 with time according to presetting. For example, in response to receiving a signal from the input unit 109 (step S803), the display control unit 108 switches the image displayed on the display unit 110 from the first medical image 106 to the second medical image 107, and the display control unit 108 starts counting of the time during which the second medical image 107 is displayed (step S804). The display control unit 108 reduces the luminance of the second medical image 107 during a preset period of time. At the same time, the display control unit 108 increases the luminance of the first medical image 106 that is not displayed on the display unit 110 according to a preset time schedule. That is, when the display unit 110 is viewed by the operator, the second medical image 107 fades out, and instead, the first medical image 106 fades in. When the manner in which the luminance is changed by the display control unit 108 is expressed as a function, the function may be linear, non-linear, exponential, logarithmic, step-like, or a combination thereof. The manner of changing the luminance of the first medical image 106 and the manner of changing the luminance of the second medical image 107 may be the same or may be different. The period of time in which the luminance of the first medical image 106 is changed by the display control unit 108 may the same or may be different as/from the period of time in which the luminance of the second medical image 107 is changed. In an embodiment, the period of time in which the luminance is changed is set to several seconds such that the operator is allowed to memorize the second medical image 107 displayed at the time of image switching, and is allowed to smoothly restart image interpretation on the first medical image displayed again on the display unit 110.

S806: Step of Switching the Displayed Image to the First Medical Image

In step S806, the display control unit 108 controls displaying on the display unit 110 so as to display only the first medical image 106. For example, when the time set in step S805 has elapsed, the luminance of the second medical image displayed on the display unit 110 becomes 0%, and the luminance of the first medical image 106 becomes 100%. That is, in step S806, the image displayed on the display unit 110 is switched from the second medical image 107 to the first medical image 106, and the displaying of the first medical image 106 on the display unit 110 is maintained unless an instruction to display the second medical image 107 is again input to the input unit 109.

When the instruction is again input to input unit 109 and the information processing apparatus 100 begins to receive the signal indicating the instruction, the process proceeds to step S803 and repeats the process up to step S806. This makes it possible to maintain displaying the second medical image 107 on the display unit 110 only for a period intended by the operator. The operator can issue an instruction to display the second medical image 107 on the display unit 110 by a simple operation input.

The doctor displays the second medical image on the display unit 110 at a desired timing, and reads necessary information. Thereafter, when a predetermined time elapses, the environment automatically transitions into a state in which it is allowed to observe only the first medical image 106. Thus, it is possible to observe the first medical image 106 when information read from the second medical image 107 such as information on a position and a shape of a lesion, a signal strength, and/or the like is being stored. Since the displayed image is switched at a timing desired by the operator between the first medical image 106 and the second medical image 107, the doctor can observe both the first medical image and the second medical image with good visibility.

The doctor can display the first medical image 106 and the second medical image 107 at a desired timing by performing a simple operation. This allows the doctor to easily repeats displaying the first medical image 106 and the second medical image 107. By repeatedly displays the first medical image 106 and the second medical image 107, the doctor can check and combine the information read from the first medical image 106 and the information read from the second medical image 107 before forgetting, which allows the doctor to observe the medical images in an efficient manner.

A specific example is described below for a case where both or one of the first medical image and the second medical image is a projected image.

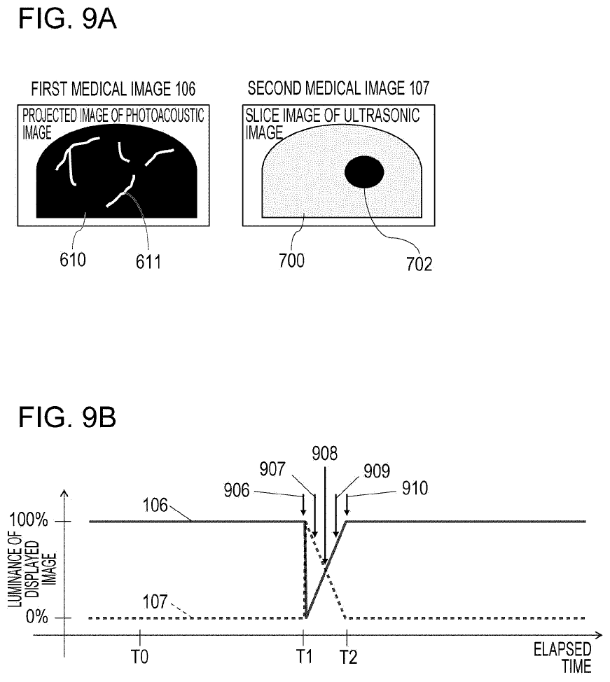

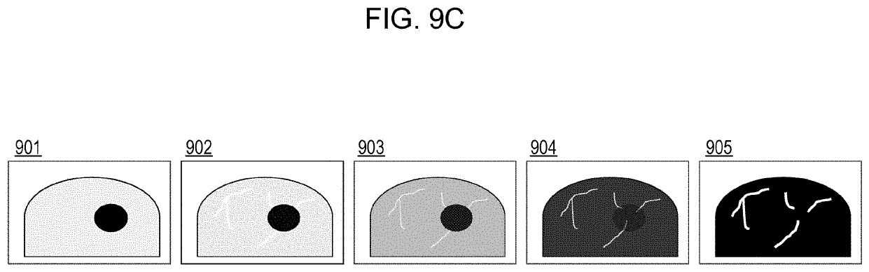

FIG. 9 is a diagram illustrating an example of a screen displayed on the display unit 110 according to the present specific example. In this example, the first medical image 106 is a projected image 610 of the photoacoustic image illustrated by way of example in FIG. 9A while the second medical image 107 is an ultrasonic image 700 illustrated by way of example in FIG. 9A. As described above, on the display unit 110, the projected image 610 and the slice image included in the ultrasonic image 700 are displayed. Note that it is assumed that the photoacoustic image of the projected image 610 and the ultrasonic image 700 have been subjected to the registration process.

FIG. 9B is a graph illustrating a temporal change of the luminance of each of the first medical image 106 and the second medical image 107 in the present specific example. Points 906 to 910 on the graph shown in FIG. 9B denote times plotted every second from time T1. In FIG. 9C, arrows indicate positions in the graph corresponding to times at which the respective images 901 to 905 are displayed.

FIG. 9C is a diagram illustrating an example of a series of screens displayed on the display unit 110 from time T1 to time T2 shown in FIG. 9B. That is, FIG. 9C shows a manner in which the first medical image 106 and the second medical image 107 are displayed while their respective luminances are changed with time. Screens 901 to 905 are examples of screens which are sequentially displayed as time elapses in a period from time T1 to time T2.

A process shown by way of example in a flow chart of FIG. 8 is described below concretely for each step.

S800: Step of Selecting a Medical Image

In step S800, the image acquisition unit 105 selects a photoacoustic image as the first medical image and volume data of the ultrasonic image 700 as the second medical image according to an instruction issued by the operator.

S801: Step of Performing Image Processing

In step S801, the image acquisition unit 105 performs the maximum intensity projection process on the photoacoustic image thereby generating the projected image 610. When the photoacoustic image is displayed as a thin slice image with a thickness of about 0.1 mm, the blood vessel image may be a dot-like image, and in this case, the connection as a blood vessel may be difficult to understand. As a result of the maximum intensity projection process, blood vessel images appearing in respective slice images are integrated into the projected image 610, which makes it possible to easily recognize connections and shapes of the blood vessels.

S802: Step of Displaying the First Medical Image

In step S802, the display control unit 108 controls displaying on the display unit 110 so as to display the first medical image 106. Step S802 corresponds to, for example, from time T0 to time T1 in the graph of FIG. 9B, and the luminance of the first medical image 106 displayed on the display unit 110 is 100%. In step S802, the second medical image 107 is not displayed on the display unit 110. That is, the luminance of the second medical image 107 is 0%.

S803: Step of Receiving a Signal from the Input Unit

In step S803, the information processing apparatus 100 receives a signal from the input unit 109. When the operator wants to display the ultrasonic image 700 on the display unit 110, the operator performs an inputting operation on the input unit 109. In response to the inputting operation, the input unit 109 transmits a signal to the information processing apparatus 100.

S804: Step of Displaying the Second Medical Image

In step S804, the display control unit 108 controls displaying on the display unit 110 so as to display a slice image of the ultrasonic image 700. Step S804 corresponds to time T1 in FIG. 9B. In the present specific example, at time T1, as shown in FIG. 9B, the luminance of the first medical image 106 becomes 0% and the luminance of the second medical image 107 becomes 100%. In this specific example, the screen 901 in FIG. 9C is displayed on the display unit 110. A slice image of the ultrasonic image 700 displayed here is a slice image at a position included in a projection range of the projected image 610 displayed on the display unit 110 immediately before time T1 at which the operator performs an inputting operation on the input unit 109. That is, the slice image is an image in the same region.

S805: Step of Changing the Luminance of the Second Medical Image

In step S805, the display control unit 108 controls the luminance of the second medical image displayed on the display unit 110 such that the luminance changes with time. More specifically, the display control unit 108 reduces the luminance of the second medical image down to 0% within a predetermined time. The display control unit 108 may change the luminance of the first medical image displayed on the display unit 110 such that the luminance changes with time within a predetermined period of time. For example, the display control unit 108 increases the luminance of the first medical image up to 100% within a predetermined period of time.

In the present specific example, the display control unit 108 changes the luminance of the first medical image 106 and the luminance of the second medical image 107 in a period of time from time T1 to T2 in FIG. 9B. The period of time from the time T1 to the time T2, that is, the period of time during which the display control unit 108 changes the luminance of the second medical image 107, is allowed to be arbitrarily set by the operator. In the present specific example, for example, the period of time from T1 to T2 is set to 5 seconds. In an example of the embodiment, the period of time in which the luminance of the second medical image 107 is changed is allowed to arbitrarily set within a range from several seconds to 10 seconds.

FIG. 9C illustrates an example of a change in the screen displayed on the display unit 110 in step S805. FIG. 9C includes screens 901 to 905 as an example of a series of screens displayed in a period of time from time T1 to time T2. In the present specific example, the period of time from time T1 to time T2 is 5 seconds, and the screens 901 to 905 are sequentially displayed every other second during 5 seconds. The times at which the screens 901 to 905 are displayed are indicated by arrows on the graph shown in FIG. 9B. In the present specific example, the luminance of each of the first medical image 106 and the second medical image 107 is changed linearly. That is, in the screens 901 to 905, the luminance of the first medical image 106 is 0%, 25%, 50%, 75%, and 100%, respectively, and the luminance of the second medical image 107 is 100%, 75%, 50%, 25%, and 0%, respectively.

The manner of changing the luminance of the second medical image 107 is allowed to be set arbitrarily by the operator. The manner of changing the luminance of the first medical image 106 is also allowed to be set arbitrarily by the operator. Furthermore, the operator is allowed to arbitrarily set whether the luminance of the second medical image 107 and the luminance of the first medical image 106 are changed in parallel. The manner of changing the luminance of the first medical image 106 and the manner of changing the luminance of the second medical image 107 may be the same or may be different.

S806: Step of Returning to the Process of Displaying the First Medical Image

In step S806, the display control unit 108 controls displaying on the display unit 110 so as to display the first medical image 106. More specifically, the luminance of the first medical image 106 displayed on the display unit 110 is 100%. The second medical image 107 is not displayed on the display unit 110, that is, the luminance of the second medical image 107 is 0%. That is, only the first medical image 106 is displayed on the display unit 110. Step S806 corresponds to time T2 in FIG. 9B.

In steps S805 and S806, the operator is allowed to change the position of the first medical image 106 and the position of second medical image 107 displayed on the display unit 110. The position may be a slice position in a three-dimensional medical image or a position in the same slice image or a position in a projected image. That is, the display control unit 108 controls displaying on the display unit 110 so as to display the first medical image 106 and the second medical image 107 at positions changed according to an inputting operation to change a position. In an example of the embodiment, the first medical image 106 and the second medical image 107 are displayed on the display unit 110 such that they are displayed at the respective corresponding positions.

As described above, the operator is allowed to perform an inputting operation at an arbitrary timing such that the second medical image 107 is displayed on the display unit 110. In an example of the above-described embodiment, the displayed image is switched from the first medical image 106 to the second medical image 107 in response to an inputting operation, and the displayed second medical image 107 is faded out and the first medical image 106 fades in within a set period of time. Thus, the operator can easily observe, for example, the position and the shape of the tumor image 702 in the second medical image 107. Furthermore, switching the displayed image again to the first medical image 106 makes it possible for the operator to easily grasp the positional relationship between the tumor image 702 and the blood vessel image 611. By displaying the first medical image 106 and the second medical image 107 on the display unit 110 while changing the luminance of each images, the operator can superimpose, in his/her head, the tumor image 702 on the first medical image 106. One example of the second embodiment may be useful when it is desired to know morphological information such as the position and the size of a tumor in performing image interpretation on the first medical image 106. Based on the information on the blood vessel image 611 obtained by observing the first medical image 106 and the information on the tumor image 702, the operator can easily know the positional relationship between them.

### Third Embodiment

In a third embodiment, in step S805 shown in FIG. 8, only the luminance of the second medical image 107 changes.

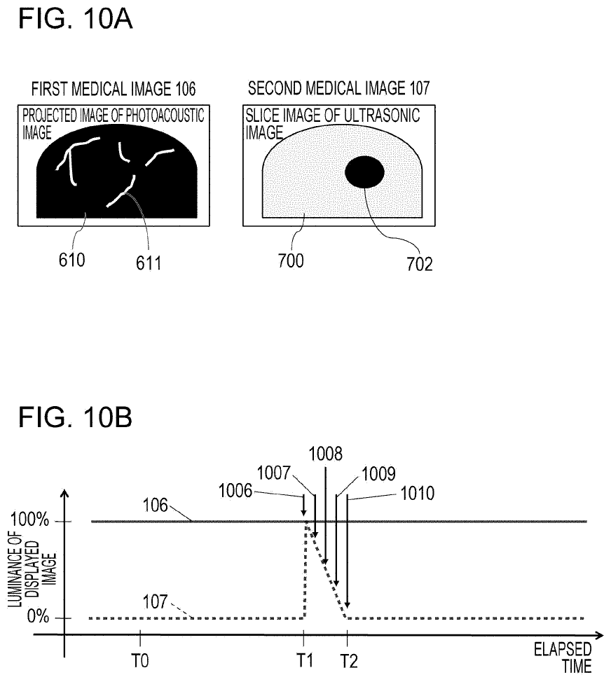

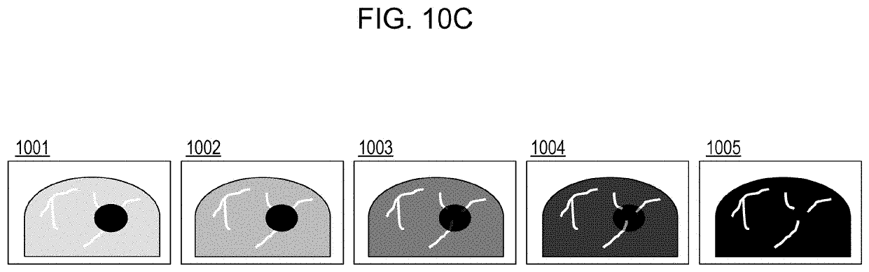

FIG. 10 is a diagram illustrating an example of a screen displayed on the display unit 110 according to a third specific example. In this example, the first medical image 106 is a projected image 610 of the photoacoustic image illustrated by way of example in FIG. 10A while the second medical image 107 is an ultrasonic image 700. As described above, on the display unit 110, the projected image 610 and the slice image included in the ultrasonic image 700 are displayed. Note that it is assumed that the photoacoustic image of the projected image 610 and the ultrasonic image 700 have been subjected to the registration process.

Hereinafter, differences from the second embodiment will be described. That is, processing in step S804 and step S805 shown in FIG. 8 will be described. Regarding steps for performing the same processing as in the second embodiment, the description thereof has been already given above and thus a further detailed description thereof is omitted.

S804: Step of Displaying the Second Medical Image

In step S804, the display control unit 108 controls displaying on the display unit 110 so as to display a slice image of the ultrasonic image 700. Step S804 corresponds to time T1 in FIG. 9B. In the third embodiment, as shown in FIG. 10B, at time T1, both the luminance of the first medical image 106 and the luminance of the second medical image 107 become 100%. On the display unit 110, the screen 1001 shown in FIG. 10C is displayed. A slice image of the ultrasonic image 700 displayed here is a slice image at a position included in a projection range of the projected image 610 displayed on the display unit 110 immediately before time T1 at which the operator performs an inputting operation on the input unit 109. That is, the slice image is an image in the same region.

S805: Step of Changing the Luminance of the Displayed Image

In step S805, the display control unit 108 controls the luminance of the second medical image 107 displayed on the display unit 110 such that the luminance changes with time. More specifically, the display control unit 108 reduces the luminance of the second medical image down to 0% within a predetermined time. However, the display control unit 108 does not change the luminance of the first medical image 106. That is, the display control unit 108 controls displaying on the display unit 110 so as to display the second medical image 107 and the first medical image 106. In the third embodiment, the display control unit 108 controls displaying on the display unit 110 such that a superimposed image of the first medical image 106 and the second medical image 107 is displayed on the display unit 110.

FIG. 10B is an example of a temporal change in luminance of the first medical image 106 and the second medical image 107. The display control unit 108 changes the luminance of the second medical image 107 in a period of time from time T1 to time T2. Here, it is assumed that the period of time in which the luminance of the second medical image 107 is changed is previously set by the operator to 5 seconds. Points 1006 to 1010 on the graph denote times plotted every second from time T1.

FIG. 10C illustrates an example of a change in the screen displayed on the display unit 110 in step S805. FIG. 10C illustrates examples of screens including screens 1001 to 1005 displayed sequentially in the period of time from time T1 to time T2. In the present specific example, the period of time from time T1 to time T2 is 5 seconds, and the screens 1001 to 1005 are sequentially displayed every other second in 5 seconds. The times at which the screens 1001 to 1005 are respectively displayed are indicated by arrows on the graph shown in FIG. 10B. In the third embodiment, the luminance of the second medical image 107 is changed linearly. That is, in the screens 1001 to 1005, the luminance of the second medical image 107 is 100%, 75%, 50%, 25%, and 0%, respectively.

At time T1, the screen 1001 is displayed on the display unit 110, and the first medical image 106 and the second medical image 107 each having luminance of 100% are superimposed and displayed. On the screen 1001, for example, the ultrasonic image 700 includes many bright areas, which may cause a reduction in visibility of the projected image 610. However, the second medical image 107 fades out with time, and thus the operator can observe the tumor image 702 and the blood vessel image 611.

The manner of changing the luminance of the second medical image 107 is allowed to be set arbitrarily by the operator. The manner of changing the luminance of the first medical image 106 is also allowed to be set arbitrarily by the operator. At time T1, if the superimposing between the first medical image 106 and the second medical image 107 causes a reduction of the visibility, the luminance range of the second medical image 107 may be set lower than 100%. For example, the luminance of the second medical image 107 may be changed within a range from 80 to 0%.

As described above, the operator is allowed to perform an inputting operation at an arbitrary timing such that the second medical image 107 is displayed on the display unit 110. For example, the operator can superimpose, in this/her head, the tumor image 702 on the first medical image 106. Based on the information on the blood vessel image 611 obtained by observing the first medical image 106 and the information on the tumor image 702, the operator can easily know the positional relationship between them.

In the third embodiment, the period of time in which the operator is allowed to observe the blood vessel image 611 of the first medical image 106 while observing the second medical image 107 is longer than in the second embodiment. That is, an example of the third embodiment is useful when the blood vessel image 611 has a specific feature in the form of vessels or in manner in which vessels extend, and an image interpretation is performed paying a particular attention on such a feature.

Modifications of the Second Embodiment and the Third Embodiment

The embodiments have been described above, by way of example, for the case where the luminance of at least one of the first medical image 106 and the second medical image 107 is changed. In other words, it may be regarded that the transparency is changed in this example. That is, it can be regarded that the process of decreasing the luminance of a medical image is a process of increasing the transparency of this medical image, and the process of increasing the luminance of a medical image is a process of decreasing the transparency of this medical image. Furthermore, the process of stopping displaying of a medical image may be regarded as a process of setting the transparency of this medical image to 100%.

The display control unit 108 may control displaying on the display unit 110 such that the first medical image 106 and the second medical image 107 are displayed on the display unit 110 in a manner in which the display method according to the second embodiment and the display method according to the third embodiment are combined. For example, when it is desired to check the position of the tumor image 702 while performing the image interpretation on the first medical image 106, the display control unit 108 may perform the processing according to the second embodiment. On the other hand, for example, when it is desired to perform an image interpretation in detail on the shape of the blood vessel image 611 related to the tumor image 702 after the tumor position has been grasped to some extent, the display control unit 108 may perform the processing according to the third embodiment.

In a case where the first medical image 106 and the second medical image 107 are both displayed on the display unit 110, the display control unit 108 may control displaying on the display unit 110 such that a superimposed image of the first medical image 106 and the second medical image 107 is displayed on the display unit 110, or the first medical image 106 and the second medical image 107 are displayed on the display unit 110 in a manner that allows it to compare them. One example of a display method that allows it to compare the first medical image 106 and the second medical image 107 is to display the first medical image 106 and the second medical image 107 side by side.

As described above, when the operator wants to display the second medical image 107, the operator performs an inputting operation on the input unit 109. The input unit 109 may be an alternate switch. In this case, the operator is allowed to display the second medical image 107 on the display unit 110 simply by pressing down the switch only once.

The input unit 109 may be a momentary switch. In this case, the input unit 109 transmits a signal indicating that an inputting operation is being performed to the information processing apparatus 100 as long as the operator keeps pressing the switch. The information processing apparatus 100 receives this signal as a signal indicating an instruction to display the second medical image 107 on the display unit 110. Time T1 shown by way of example in FIG. 9 and FIG. 10 corresponds to a point of time at which the signal from the input unit 109 starts to be received. In a case where the operator ends the inputting operation on the momentary switch within a predetermined period of time (within 5 seconds in the example according to the embodiment described above), the display control unit 108 may stop displaying the second medical image 107 when the reception of the signal from the input unit 109 ends, and may display only the first medical image 106. In this case, a point of time when the reception of the signal from the input unit 109 ends corresponds to time T2 shown by way of example in FIG. 9 and FIG. 10. In a case where the operator continues the inputting operation on the momentary switch for a period of time longer than a predetermined period of time, the display control unit 108 may switch the displaying mode when the predetermined period of time has elapsed such that only the first medical image 106 is displayed as in the embodiments described above. In another example, the second medical image 107 may be again displayed on the display unit 110 when the predetermined period of time has elapsed as is performed at time T1. As long as the operator continues the inputting operation on the momentary switch, the display control unit 108 may repeatedly display images from time T1 to time T2, that is, the screens 901 to 905 illustrated by way of example in FIG. 9 or the screens 1001 to 1005 illustrated by way of example in FIG. 10.

The embodiment has been described above, by way of example but not limitation, for the case where the display control unit 108 receives a signal transmitted from the input unit 109. Alternatively, for example, the information processing apparatus 100 may include receiving means (not shown) that is a module different from the display control unit 108 and that is configured to receive a signal transmitted from the input unit 109.

In the embodiments described above, by way of example, the luminance is changed linearly. However, the present invention is not limited to this. For example, the display control unit 108 may change the luminance of the first medical image or the second medical image according to an exponential function, a logarithmic function, or an arbitrary nonlinear function.

Modifications of First to Third Embodiments

The present invention may also be implemented such that a program to realize one or more functions of the above-described embodiments is supplied to a system or apparatus via a network or a storage medium, and one or more processors in a computer of the system or apparatus read and execute the program. The present invention may also be implemented by a circuit (for example, ASIC) that realizes one or more functions.

The information processing apparatus according to one of the above-described embodiments may be realized as a single apparatus, or may be realized in a form in which a plurality of apparatuses are communicably combined to execute the above-described processing. Note that any of these modification falls into the scope of the embodiments of the invention. The above-described processing may be executed by a common server device or server group. The information processing apparatus and the plurality of apparatuses constituting the information processing system need only be able to communicate at a predetermined communication rate, and do not need to be in the same facility or in the same country.

Embodiments of the present invention include an embodiment in which a software program to realize a function of the above-described embodiments is supplied to a system or apparatus, and a computer of the system or the apparatus reads and executes the supplied program.

That is, the program code itself installed in the computer in order to realize processing according to any embodiment also falls within the scope of the embodiments of the present invention. Furthermore, a function of the embodiments can also be realized by an OS or the like running on a computer by performing part or all of actual processes according to an instruction included in a program read by the computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
an acquisition unit configured to acquire a first medical image and a second medical image; and
a display control unit configured to control displaying on a display unit such the second medical image is displayed on the display unit for a period for which one operation is being performed on an accepting unit configured to accept an operation performed by an operator, the first medical image is displayed on the display unit instead of the second medical image when the one operation on the user operation accepting unit is ended.

2. The information processing apparatus according to claim 1, further comprising
a changing unit configured to change a position, in the second medical image, of a second two-dimensional image which is a two-dimensional image included in the second medical image,
wherein the display control unit controls displaying on the display unit such that when the one operations is ended, a first two-dimensional image is displayed on the display unit the first two-dimensional image being such an image which is included in the first medical image and which corresponds to a position of a second two-dimensional image whose position has been changed by the changing unit in the period in which the one operation is being performed.

3. The information processing apparatus according to claim 2, wherein
the first two-dimensional image is a slice image of the first medical image, and the second two-dimensional image is a slice image of the second medical image, and
the display control unit controls displaying on the display unit such that when the one operation ends, the first two-dimensional image at a position changed in a direction in the subject in the first medical image corresponding to a direction in the subject in the second medical image in which the change was made.

4. The information processing apparatus according to claim 1, wherein
the display control unit controls displayed on the display unit such that the second medical image is displayed on the display unit only for the period in which the one operation is being performed.

5. The information processing apparatus according to claim 1, wherein
the accepting unit is a momentary switch, and the one operation is pressing-down of the momentary switch.

6. The information processing apparatus according to claim 5, wherein
the accepting unit is configured to transmit a signal in response to pressing-down of the momentary switch and end transmitting the signal in response to ending of the pressing-down of the momentary switch, and the period for which the one operation is being performed is defined by a period for which the accepting unit is transmitting the signal.

7. An information processing apparatus comprising:
an acquisition unit configured to acquire a first medical image and a second medical image,
a display control unit configured such that in response to an inputting operation performed by an operator, the second medical image is displayed on a display unit and luminance of the displayed second medical image is reduced within a predetermined period of time, and in response to the inputting operation, luminance of the first medical image is reduced and the reduced luminance of the first medical image is increased.

8. The information processing apparatus according to claim 7, wherein
the display control unit displays controls displaying on the display unit such that the first medical image is displayed on the display unit, and, in response to the inputting operation performed, the second medical image is displayed on the display unit.

9. The information processing apparatus according to claim 7, wherein
the display control unit controls displaying on the display unit such that the first medical image is displayed on the display unit, then in response to an occurrence of the inputting operation, displaying of the first medical image is stopped, and the second medical image is displayed on the display unit, and thereafter luminance of the displayed second medical image is reduced within a predetermined period of time and luminance of the first medical image is increased within the predetermined period of time thereby displaying the first medical image on the display unit.

10. The information processing apparatus according to claim 7, wherein
the display control unit controls displaying on the display unit such that the first medical image is displayed on the display unit, then in response to an occurrence of the inputting operation, the second medical image is displayed on the display unit while maintaining luminance of the first medical image, and thereafter, while maintaining the luminance of the first medical image, luminance of the second medical image is reduced within a predetermined period of time.

11. The information processing apparatus according to claim 1, wherein
the acquisition unit acquires the first medical image and the second medical image registered with the first medical image, and
the display control unit controls displaying on the display unit such that the second medical image at a position corresponding to the first medical image is displayed on the display unit.

12. The information processing apparatus according to claim 11, wherein
the display control unit controls displaying on the display unit so as to display the second medical image at a position corresponding to the first medical image displayed on the display unit at a point of time when the inputting operation is performed.

13. The information processing apparatus according to claim 1, wherein
the first medical image and the second medical image each are a medical image based on an acoustic wave from a subject.

14. The information processing apparatus according to claim 1, wherein
at least one of the first medical image and the second medical image is a projected image obtained via a maximum intensity projection process on a three-dimensional image.

15. The information processing apparatus according to claim 1, wherein
at least one of the first medical image and the second medical image is a superimposed image obtained by superimposing a plurality of medical images based an acoustic wave from a subject.

16. The information processing apparatus according to claim 1, wherein
the first medical image is a photoacoustic image that is an image based on a photoacoustic wave obtained by irradiating a subject with light, and the second medical image is an ultrasonic image that is an image based on a reflected wave appearing as a result of a reflection, inside the subject, of an acoustic wave applied to the subject.

17. An information processing apparatus comprising:
an acquisition unit configured to acquire a first medical image and a second medical image; and
a display control unit configured to control displaying on a display unit such that the second medical image is displayed on the display unit for a period for which a signal is being received which is a signal indicating an instruction to display the second medical image on the display unit and which is transmitted for a period for which one inputting operation is performed by an operator,
while the first medical image is displayed on the display unit for a period for which the signal is not received.

18. An information processing apparatus comprising:
an acquisition unit configured to acquire a first medical image and a second medical image; and
a display control unit configured to control displaying on a display unit such that at least one of the first medical image and the second medical image is displayed on the display unit;
a changing unit configured such that in a case where, in a period of time for which the second medical image is being displayed on the display unit, an instruction is issued to change a position, in the second medical image, of a second two-dimensional image which is a two-dimensional image included in the second medical image,
the changing unit changes a position of a first two-dimensional image included in the first medical image to a position corresponding to the changed position of the second medical image.

19. An information processing system comprising:
an acquisition unit configured to acquire a first medical image and a second medical image; and
a display control unit configured to control displaying on a display unit such the second medical image is displayed on the display unit for a period for which one operation is being performed on an accepting unit configured to accept an operation performed by an operator, the first medical image is displayed on the display unit instead of the second medical image when the one operation on the user operation accepting unit is ended.

20. An information processing system comprising:
an acquisition unit configured to acquire a first medical image and a second medical image; and
a display control unit configured to control displaying on a display unit such that the second medical image is displayed on the display unit for a period for which a signal is being received which is a signal indicating an instruction to display the second medical image on the display unit and which is transmitted for a period for which one inputting operation is performed by an operator,
while the first medical image is displayed on the display unit for a period for which the signal is not received.

21. The information processing system according to claim 20, further comprising
accepting unit configured to accept an operation performed by the operator.

22. An information processing system comprising:
an acquisition unit configured to acquire a first medical image and a second medical image; and
the information processing apparatus being configured such that in response to an inputting operation performed by an operator, the second medical image is displayed on a display unit and luminance of the displayed second medical image is reduced within a predetermined period of time, and in response to the inputting operation, luminance of the first medical image is reduced and the reduced luminance of the first medical image is increased.

23. An information processing method comprising steps of:
acquiring a first medical image and a second medical image; and
controlling displaying on a display unit such the second medical image is displayed on the display unit for a period for which one operation is being performed on an accepting unit configured to accept an operation performed by an operator, the first medical image is displayed on the display unit instead of the second medical image when the one operation on the accepting unit is ended.

24. An information processing method comprising steps of:
acquiring a first medical image and a second medical image; and
display control unit configured to control displaying on a display unit such that the second medical image is displayed on the display unit for a period for which a signal is being received which is a signal indicating an instruction to display the second medical image on the display unit and which is transmitted for a period for which one inputting operation is performed by an operator, and
displaying the first medical image on the display unit for a period for which the signal is not received.

25. An information processing method comprising steps of:
acquiring a first medical image and a second medical image;
controlling displaying on a display unit such that the first medical image is displayed on a display unit;
receiving a signal which indicates an instruction to display the second medical image on the display unit and which is transmitted for a period of time for which one inputting operation is being performed by an operator;
controlling displaying on the display unit such that the second medical image is displayed on the display unit for a period for which the signal is being received; and
controlling displaying on the display unit such that the first medical image is displayed on the display when the receiving of the signal is ended.

26. An information processing method comprising steps of:
acquiring a first medical image and a second medical image;
displaying a first two-dimensional image included in the first medical image on a display unit;
replacing the first two-dimensional image displayed on the display unit with a second two-dimensional image included in the second medical image;
accepting a change in a position, in the second medical image, of the second two-dimensional image;
displaying the second two-dimensional image at the changed position on the display unit;
changing the position of the first two-dimensional image to a position corresponding to the changed position in the second medical image; and
replacing the second two-dimensional image displayed on the display unit with the first two-dimensional image at the changed position.

27. An information processing method comprising steps of:
acquiring a first medical image and a second medical image;
controlling displaying on a display unit such that the first medical image is displayed on a display unit;
in response to an inputting operation performed by an operator, displaying the second medical image on the display unit, and stopping displaying of the first medical image;
reducing luminance of the displayed second medical image within a predetermined period of time, and increasing luminance of the first medical image within the predetermined period of time and displaying the first medical image on the display unit; and
when the predetermined period of time elapsed, stopping displaying the second medical image and displaying the first medical image on the display unit.

28. A non-transitory computer-readable medium storing a program for causing a computer to execute the information processing method according to claim 23.

29. A non-transitory computer-readable medium storing a program for causing a computer to execute the information processing method according to claim 24.

30. A non-transitory computer-readable medium storing a program for causing a computer to execute the information processing method according to claim 25.

31. A non-transitory computer-readable medium storing a program for causing a computer to execute the information processing method according to claim 26.

32. A non-transitory computer-readable medium storing a program for causing a computer to execute the information processing method according to claim 27.

33. A non-transitory computer-readable medium storing a program for causing a computer to execute the information processing method according to claim 28.
